(19) United States
(12) Patent Application Publication
(10) Pub. No.: US 2007/0226298 A1
(43) Pub. Date: Sep. 27, 2007

(54) Methods and systems providing metadata in service signatures

(75) Inventor: Udo Klein, (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: SAP AG.

(21) Appl. No.: 11/388,831

(22) Filed: Mar. 24, 2006

(51) Int. Cl. G06F 15/16

(52) U.S. Cl. 709/206

(57) ABSTRACT

Methods and systems providing metadata-containing messages that will minimize any adverse impact on processing of a service when raised. A metadata-containing message may be declared in a signature of a service. When a condition corresponding to the message occurs during service processing, the message may be generated while minimizing any adverse impact on processing of the service. The message may be made available to an entity interested in the message.

### BACKGROUND

I. Technical Field

The present invention relates generally to systems and methods providing metadata in service signatures. More particularly, the present invention relates to methods and systems providing metadata-containing messages while minimizing adverse impact on service processing when raised.

II. Background Information

As known in the art, computer software applications may comprise one or more methods, sometimes called “services.” A method may consist of code implementing the behavior specified by an operation. A method may be associated with a particular class (class method) or object (instance method). Typically, a method includes a service signature containing metadata defining and describing the method. For example, a service signature may detail the method's input parameters and the type of output the method delivers. In addition, the signature may specify exceptions (i.e. error indicators) that the method may deliver. For example, the method may include code enforcing certain preconditions that are used to constrain the method's input parameters and post-conditions used to constrain the method's output. If one of the preconditions or post-conditions is not met, an exception corresponding to the unmet condition may be raised (i.e. thrown).

FIG. 1 is an exemplary service signature 100 associated with a method for converting a value in one set of units, such as miles, to another set of units, such as kilometers. Signature 100 may comprise an access level 102 defining the required security level needed to access the method. Signature 100 may also comprise a return type 104 specifying the data type of the values the method returns. In FIG. 1, return type 104 indicates that the output value is a “float,” or a floating-point number variable. Signature 100 may comprise a method name 106, which is illustrated in FIG. 1 as “converts.” Information may be passed into the method via arguments. Signature 100 may declare an argument 108, shown in FIG. 1 as “int units_in,” to indicate that an integer associated with a particular type of units to be converted into another type of units is input into the method. Signature 100 may also declare a second argument 110, shown in FIG. 1 as “float value,” to indicate that a floating-point number variable associated with the value to be converted is input into the method. Signature 100 may also include an argument 112, shown in FIG. 1 as “int units_out,” to indicate that an integer associated with a particular type of units to be converted into from another type of units is input into the method. Signature 100 may also include one or more exceptions 114 that may be raised during method processing. FIG. 1 illustrates an exception “conversion_rate_unknown” that may be triggered when the method does not know the conversion rate between the units of the input value and the desired output units.

Exposing the exceptions that a method may raise during processing in the service signature is helpful to clients calling the method, because clients are informed of what exceptions to expect. Thus, at design time, persons developing client software can include code dealing with specific exceptions, and can also attempt to conform input to avoid raising exceptions. For example, a method may be operative to convert a value in one type of units to another type of units, such as from miles to kilometers. By informing the calling client of the nature of the exceptions, the calling client may be enabled to react to various exceptions differently. For example, the client may react to an exception raised because the input unit is incompatible with the output unit differently than it reacts to an exception raised because the conversion rates between the input and output units are unknown.

Typically, raising exceptions causes the method to cease processing. Accordingly, exceptions limit the mass processing capabilities of operations by preventing the method from continuing after the first exception is raised. This may be disadvantageous when the method accepts multiple lines of input, as the client can be informed of only one error at a time. For example, the unit-conversion method discussed above may accept a table of values input by the client. If the first line of input comprises an error, an exception is raised and the method ceases operation. While this may be only slightly inconvenient if there are just a few lines of input, it can be a large burden on overhead and processing time if a large number of lines are input. For example, if 1,000 lines of code are entered and 100 lines raise exceptions, the burden is considerable, as each exception will cease operation of the method and require the client to fix that exception before continuing, a process that will be repeated until all exceptions are separately raised and handled.

Indicating error situations through the use of fault messages is also known in the art. Fault messages differ from exceptions in that fault messages do not terminate method flow when generated. Thus, fault messages are generally more amenable to mass processing than exceptions. However, fault messages typically are not declared in the service signature and do not contain declarative metadata (i.e. information describing the origin, location, or other characteristics of the message). Accordingly, developers of clients that may call the method are unable to prepare for messages that may be generated during processing of the method. Thus, neither exceptions nor fault messages, as typically implemented, are well-suited for both (i) indicating to a client calling a method what errors may be generated by the method and (ii) conducive to mass-processing operations.

### SUMMARY

Consistent with the principles of the present invention, systems and methods provide metadata-containing messages to interested entities while minimizing impact on service processing when generated. In one aspect, a method consistent with the principles of the present invention may be implemented by a computer processor coupled to a memory. The method may comprise declaring a metadata-containing message in a signature of a service. The method may further comprise generating the message in a manner minimizing adverse impact on service processing when a condition corresponding to the message occurs. The method may further comprise making the message available to an entity interested in the message.

In another aspect, a system may comprise a memory and a processor coupled to the memory. The processor may be operable to declare a metadata-containing message in a signature of a service. The system may further be operable to generate the message upon the occurrence of a condition corresponding to the message in a manner minimizing adverse impact on service processing. The system may also be operable to make the message available to an entity interested in the message.

In accordance with yet another aspect, a computer-readable medium stores a set of instructions that, when executed, performs a method. The method may comprise declaring a metadata-containing message in a signature of a service. The method may further comprise generating the message in a manner minimizing adverse impact on service processing when a condition corresponding to the message occurs. The method may also comprise making the message available to an entity interested in the message.

It is to be understood that both the foregoing general description and the following detailed description are exemplary and explanatory only, and should not be considered restrictive of the scope of the invention, as described and claimed. Further, features and/or variations may be provided in addition to those set forth herein. For example, versions of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 illustrates an exemplary service signature.

FIG. 2 is a block diagram illustrating the operation of an exemplary system consistent with the principles of the present invention.

FIG. 3 is a flow chart illustrating the operation of an exemplary system consistent with the principles of the present invention.

FIG. 4 is a flow chart illustrating the operation of an exemplary system consistent with the principles of the present invention.

FIG. 5 is a flow chart illustrating the operation of an exemplary system consistent with the principles of the present invention.

FIG. 6 is a diagram illustrating an inheritance tree consistent with the principles of the present invention on a computer network.

FIG. 7 is a block diagram illustrating the operation of an exemplary system consistent with the principles of the present invention.

FIG. 8 is a block diagram illustrating an implementation of an exemplary system consistent with the principles of the present invention on a personal computer.

FIG. 9 is a block diagram illustrating an implementation of an exemplary system consistent with the principles of the present invention.

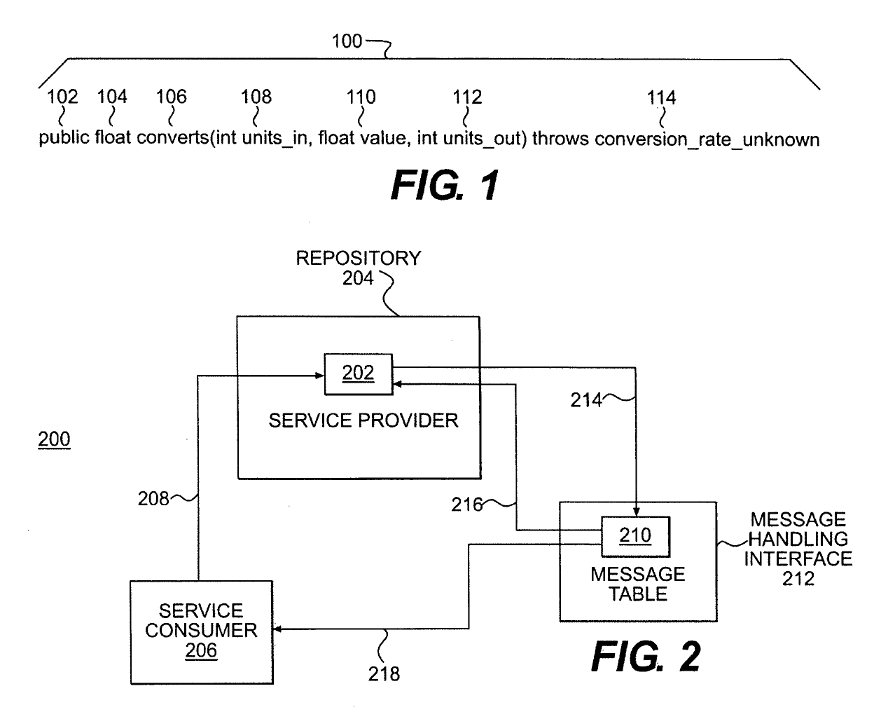

### DETAILED DESCRIPTION

The following detailed description refers to the accompanying drawings. Wherever possible, the same reference numbers are used in the drawings and the following description to refer to the same or similar parts. While several exemplary versions and aspects of the invention are described herein, modifications, adaptations and other implementations are possible without departing from the spirit and scope of the invention. For example, substitutions, additions and/or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

As embodied herein, methods and systems provide metadata-containing messages that minimize adverse impact on a service when raised during processing. Consistent with the principles of the present invention, a service provider may perform a service, or method, called by a client. The service provider may be an object in an object-oriented system. For example, the service provider may be a business object that encapsulates data and/or behavior associated with the entity the business object represents. The service may comprise a signature. The signature may comprise input parameters and output type. Often, certain preconditions and/or post-conditions must be met for a method to operate properly. In systems known in the art, the signature may comprise a list of exceptions that may be raised during processing of the service if any of the conditions are not met. If an exception is raised, the service terminates.

Consistent with the principles of the present invention, a service signature may include metadata that exposes messages that may be generated during processing of the method. However, unlike systems known in the art, when a condition is provoked during operation of the service, a message corresponding to the condition may be passed to an entity interested in the entity while minimizing adverse impact on processing of the service, such that it appears to the service consumer as though processing is not halted because the consumer is not required to deal with the raised messages before continuing service processing. In this manner, messages may be passed to interested entities while allowing the service to finish processing, even when multiple messages are triggered. Consistent with the principles of the present invention, messages may be passed to one or more interested entities, including, for example, the service consumer or even the service provider itself.

As discussed in detail below, messages may contain metadata of various attributes relating to the message, thus informing the consumer of the basis for the message. In this manner, a developer of client software that might call the service may be informed of the messages that may be triggered during operation of the service and include code to handle those circumstances. Further, at runtime, passing the metadata associated with messages may inform the client of relevant information regarding messages.

FIG. 2 is an illustration of an exemplary system 200, discussed in detail below, consistent with the principles of the present invention. System 200 may comprise a service provider 202. Service provider 202 may be located in a repository 204, in which service providers and messages may be defined and stored. Service provider 202 may be called by a service consumer 206 to perform a service, as indicated by arrow 208. Operation of the service performed by service provider 202 may trigger one or more messages. Messages raised or created during service processing may be appended to a message table 210 located in a message handling interface 212, as indicated by arrow 214. Service provider 202 may be interested in certain messages raised during processing. Accordingly, service provider 202 may receive messages from message table 210, as indicated by arrow 216.

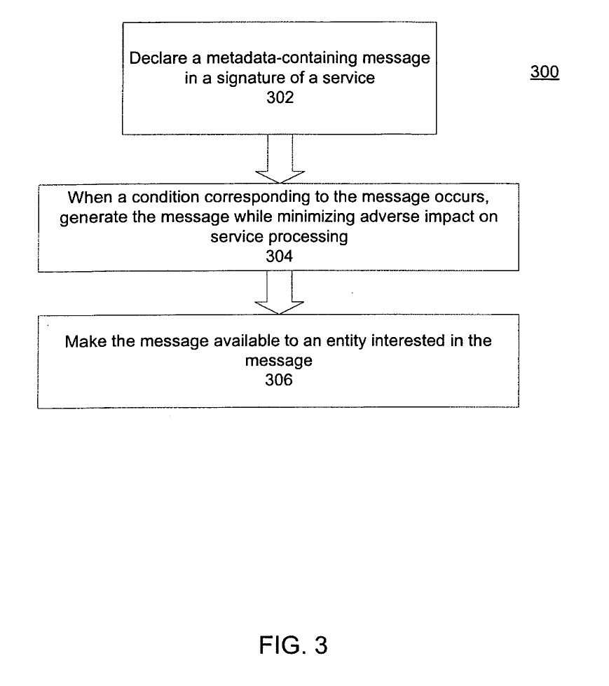

FIG. 3 is a flow chart illustrating the operation of an exemplary system 300 consistent with the principles of the present invention. In system 300, a metadata-containing message may be declared in a signature of a service (302). When a condition corresponding to the message occurs, system 300 may generate the message while minimizing adverse impact on service processing (304). System 300 may make the message available to an entity interested in the message (306).

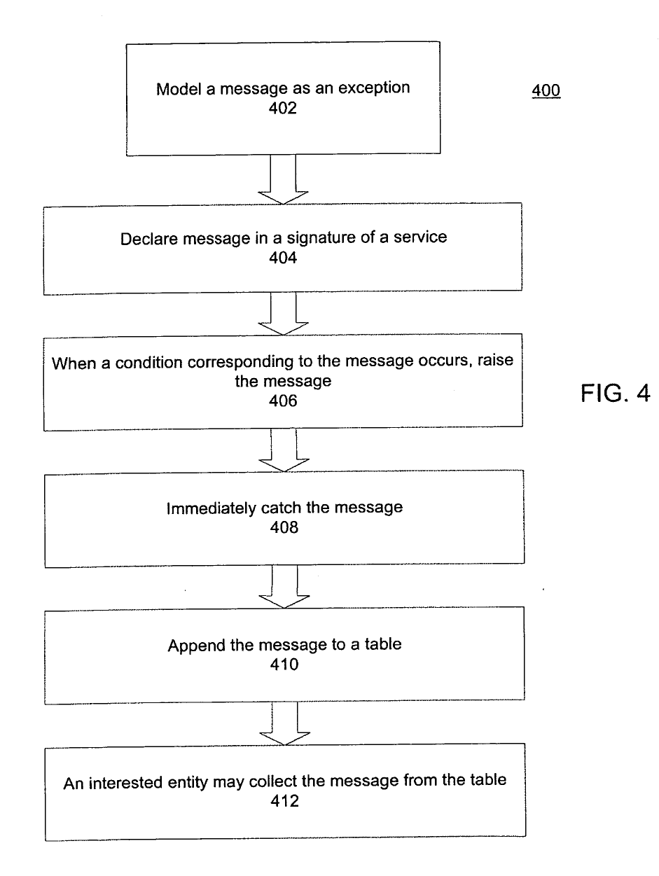

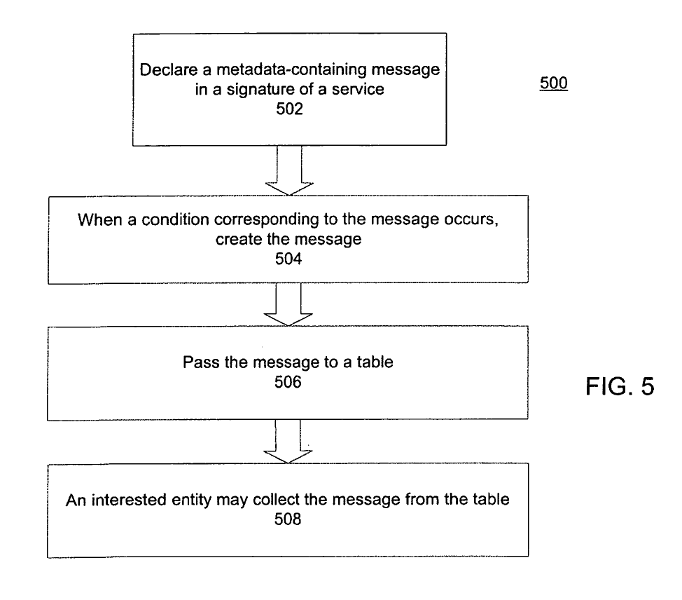

FIG. 4 is a flow chart illustrating the operation of an exemplary system 400 consistent with the principles of the present invention. In system 400, a message may be modeled as an exception (402) and declared in a signature of a service (404). When a condition corresponding to the message occurs, system 400 may raise the message (406). System 400 may immediately catch the message, allowing processing to continue and minimizing the adverse impact on processing caused by raising the message (408). System 400 may append the message to a table (410). An entity interested in the message may collect the message from the table (412).

FIG. 5 is a flow chart illustrating the operation of an exemplary system 500 consistent with the principles of the present invention. In system 500, a metadata-containing message may be declared in a service of a signature (502). When a condition corresponding to the message occurs, system 500 may create the message (504). System 500 may pass the message to a table (506). An interested entity may collect the message from the table (508).

Messages

Consistent with the principles of the present invention, services that may be called by service consumers (i.e. clients) may be defined and stored in a repository, such as repository 204 illustrated in FIG. 2. Additionally, messages that may be generated by operation of services may be stored and defined in the repository. Messages may be classified in various ways, such as by symptom and/or severity. Messages may also be categorized in various ways. For example, a message may be categorized based on whether it remains internal to the service provider or whether it appears outside the service provider, such as when the message is passed to the service consumer.

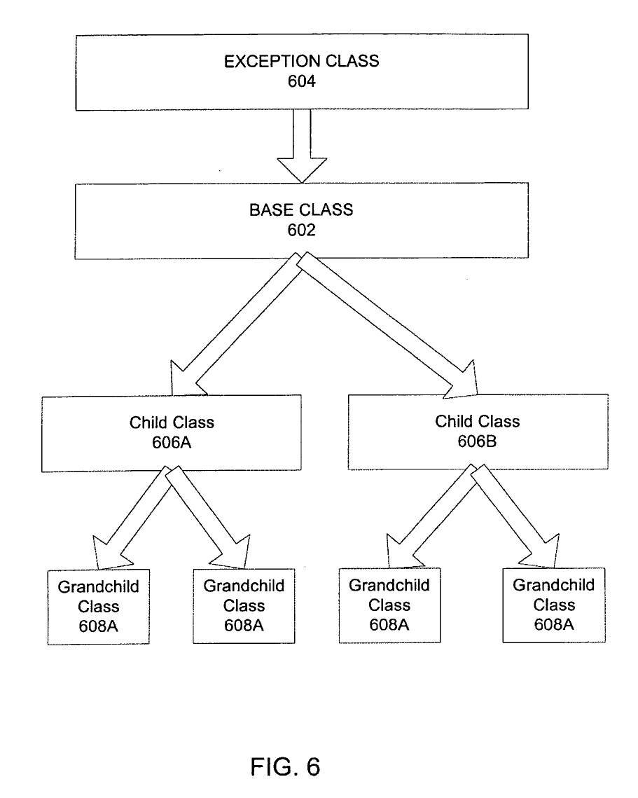

Messages provided to interested entities may be examples, or instances, of message classes. A message class may comprise particular attributes. Each message modeled from a particular message class may thus comprise the attributes of that class. In certain aspects consistent with the present invention, messages may be modeled using an inheritance tree. FIG. 6 illustrates an exemplary inheritance tree 600. In one aspect, messages may be modeled from a base message class 602 providing a set of standardized attributes, or metadata. Base class 602 may inherit from a higher class. Message instances may be modeled from an exception class, as illustrated in FIG. 6. By modeling base message class 602 on an exception class, base message class 602 may include the attributes of an exception, allowing messages to be declared as exceptions in a service signature and include metadata.

As illustrated in FIG. 6, child classes 606a and 606b may inherit from base class 602. Child classes 606a, 606b may include each of the attributes of base class 602, and may include additional attributes, as well. Grandchild classes 608a-d may inherit from child classes 606 in a similar fashion.

As discussed above, message instances may inherit from a base class. The base class may offer attributes such as a message ID, a symptom and/or a severity. The message ID may comprise a globally unique identifier (GUID) for the message. The GUID may serve to identify the message instance. In certain aspects, the service consumer may use a framework to fill the message ID field, thus defining message instances.

The base class may also be able to contain, or cluster, “detail messages.” The “detail messages” may be one or more sub-messages clustered within the base message. Each of the “detail messages” may comprise messages in their own right. By allowing a message to cluster “details messages,” the message may contain one or more sub-messages, each of which comprises a message in its own right. The “detail messages” attribute may comprise a table of message IDs. The details may contain IDs of messages that are present in a message buffer, enabling the service consumer to navigate to the detail messages. The detail messages may point to different locations than the clustering message. It should be noted that pointing to messages originating outside the service provider can be problematic in that the service provider does not control the existence of external messages, meaning that dangling references are possible.

In addition to the attributes inherited by the base class, the base class may also add additional attributes. For example, the base class may add attributes such as lifetime, origin location and environment location. Attributes may be of simple types, such as “char” (data type used to store fixed-length character data), “string” (a sequence of characters considered as a whole), or “int” (a whole number). In certain aspects, structured, nested, tabular or referential attributes may not be permitted. In other aspects, attributes may not contain references to other messages, so that messages may be serialized in a reasonable fashion.

The lifetime attribute may comprise values such as “transition” or “state.” “Transition” may imply that a message was triggered because an operation fails to execute. For example, the operation may fail to execute because a lock cannot be acquired or because the user is missing an authorization. A user interface may display “transition” messages when they are triggered, then drop them afterwards. By providing metadata to the service consumer indicating the nature of the message, the developer of the service consumer may provide code reacting appropriately to messages. For example, the developer of a service consumer may provide code instructing the service consumer when to drop a “transition” message. A “State” attribute may imply that the message was triggered because a service provider node, such as a field of a business object, is inconsistent. For example, a “state” message may be generated if a submitted amount exceeds an applicable limit or because a foreign key is wrong. “State” messages may imply that a change to the service provider or its environment is necessary, and may be displayed on a user interface until the corresponding node is evaluated. However, as with “transition” attributes, exposing message metadata to developers of service consumers allows developers to provide code dealing with “state” attributes, including when such messages should be dropped.

The origin location attribute may describe the location in the modeling architecture at which the message was generated. Clients may use this for navigational purposes. For example, if an error is generated because the total sum of a set of records exceeds some limit, the origin location attribute may point to the location where the total sum is stored.

The environment location attribute may comprise a table of location structures. The environment location attribute may inform the client of alternative navigation targets for error resolution (e.g., in the case of a message indicating the existence of a foreign lock, the identity/location of the locking user). Clients may use the environment location attribute as a secondary navigation target. For example, if an error is triggered because the total sum of a set of records exceeds an allowed limit, the environment location attribute may point at all records involved in the summation.

The message attributes may also comprise the message location. The message location may include the service provider name, the service provider node name, the service provider node ID, as well as one or more fields. In certain aspects, the service provider name may be mandatory, as messages may not be created outside of service providers. The “fields” may comprise a table including field name, value and type in the service provider structure belonging to the message. The fields may be highlighted by a user interface displaying the message. The fields may be presented in an external global data type (GDT) format. The type may give the GDT. The type information may assist in rendering the fields correctly if the message is restored from persistency without its original service provider context.

Consistent with the principles of the present invention, messages may be stored in a T100 database table (“T100 message”). As known in the art, T100 messages may consist of an ID, a short text (with up to four placeholders) and a long text (with up to four placeholders). A T100 message class may inherit from a base class, such as base class 602 illustrated in FIG. 6, and may offer additional attributes such as a T100 message number, a T100 message class, and one or more message variables. The message variables may be in string format, meaning that the system may not provide any dedicated output conversions. Accordingly, a T100 client may fill the fields in a human-readable format.

In another aspect, the system may allow messages to be declared in the signature. Because services may be defined in a repository, this may be accomplished by a repository extension adding code to the repository operative to extend the repository's functionality to allow service developers to declare messages in the service signature.

Repository Interface

Service providers, messages, as well as other objects, may be defined and stored in a repository. The repository interface may comprise a user interface for modeling messages. Messages may be modeled from metadata contained in the repository using a proxy-generation tool, such as SPROXY, available from SAP AG, Walldorf, Germany. In certain aspects, the repository interface may allow messages to be modeled as exception classes, allowing the messages to include metadata and be declared in service signatures. In certain aspects consistent with the principles of the present invention, the repository may comprise an inheritance tree, allowing messages to inherit from more one or more generic classes. However, an inheritance tree is not necessary to implement the present invention. In other aspects, messages may be declared in the service signature without being modeled as exception classes.

As described above, messages may comprise attributes inherited from the base class, discussed above, and may also include attributes such as message type and message ID. For example, the repository may comprise a base class “CM_Root.” In certain aspects, as mentioned above, the base class “CM_Root” may inherit from an exception class, allowing the messages to be modeled as exceptions. All message classes may be some derivative of the base class. For example, messages such as “CM_units_unknown” or “CM_limit_exceeded” may derive from the exemplary base class “CM_Root” contained in the repository. In this manner, messages may be passed to interested entities with metadata allowing the interested entity to respond to the messages appropriately. The message-naming convention may indicate to the service the manner in which the messages are to be handled when raised. For example, if the messages are modeled as exceptions, the naming convention may indicate that the messages do not permanently terminate service processing. In aspects in which messages are not modeled as exceptions, the naming convention may indicate that the messages are not exceptions, and that processing need not be terminated upon the raising of a message.

Instead, the messages may be specially implemented so that they minimize adverse impact on processing. Consistent with the principles of the present invention, raising a message may terminate processing for a brief period that is not apparent to the service consumer. At runtime, messages may be checked for compliance with the declarations of the repository. If a message does not comply with the repository's declarations, processing may be terminated.

Messages Inside the Service Provider

Messages generated during processing of a service may remain inside a service provider to allow the service provider to respond to the condition triggering the message. Messages may comprise metadata informing the service provider of message attributes, allowing the service provider to respond appropriately to different messages. In certain aspects, as discussed above, the messages may inherit from exception classes, and may therefore technically comprise exception classes. The messages may be declared in the service signature, and may be raised during processing of the service like typical exceptions. However, as discussed below, the messages may differ from traditional exception classes in that the raising of a message may minimally impact service processing. The messages may be declared in a manner indicating to the system that the messages are not to be treated as typical exceptions. For example, the messages may be named according to a special convention indicating their special status. Upon raising a message, the system may be operative to terminate processing. However, the system may promptly catch the message, allowing processing to restart. Consequently, to the service consumer it appears as though processing was not interrupted by raising the message. The message may then be collected by the service provider, allowing it to take the appropriate action.

In other aspects, the system may be operative to “create” messages modeled as exceptions upon the occurrence of a triggering event, such as through the use of a CREATE statement. By “creating” messages, the messages are not raised, and service processing is not terminated. Because they are modeled as exceptions, the messages may contain informative metadata. Created messages may be passed to interested entities, including the service provider. For example, created messages may be passed to a table structure, from which they may be retrieved by the interested entity. However, if messages are “created” rather than “raised,” it may be more difficult to determine where the message was created. For example, a “breakpoint on raise” command could not be used to determine at which point in processing the message was created, whereas the command could be used to determine the triggering point if messages are raised.

In other aspects, the system may allow messages to be declared in the service signature, meaning that messages need not be declared as exceptions. A language extension may allow messages to be declared in the service signature without the need to model them as exceptions. A language extension may provide a mechanism allowing the service provider to accept messages triggered during processing. The service provider may comprise a runtime extension ensuring that only declared messages can pass through the service's boundaries; hence, the service consumer may be assured that only declared messages will appear. In this manner, the developer of a service consumer may provide code to handle all messages that may arise during service processing because all possible messages are exposed to the service consumer in the service signature. The service provider may also comprise a runtime extension allowing it to accept messages.

Service providers may receive messages in various manners consistent with the principles of the present invention. For example, messages raised or created during service processing may be collected in a table. The service provider may be operative to collect messages stored in the table. The developer of the service provider may provide code allowing the service to respond appropriately to messages collected from the table. In certain aspects, the service may be implemented in a tree structure rather than as a call stack. In this manner, the flow of service processing may diverge in reaction to a triggered message, allowing the service to react appropriately to the condition resulting in a message.

Messages for Service Consumers

Messages may be exposed to entities outside the service provider, such as the service consumer. The attributes included in the messages may vary depending on design choice. However, in certain aspects consistent with the principles of the present invention, the messages may contain all the information included in the abstract message class described above. In addition, the exposed messages may include the message type (i.e. class name), the message ID and/or the text ID. The message ID may identify the text of the message independent of the language of the service consumer. The text ID may be used to scan for identical messages.

Exposing metadata-containing messages to service consumers may be implemented through various techniques consistent with the principles of the present invention. In certain aspects, the repository may allow messages to be modeled as exception classes in the signature of a service. If, during processing of the service, a message is triggered, processing may terminate. Unlike a typical exception, however, the message may be caught without requiring any intermediate action by the service provider or service consumer, thus allowing processing to continue. In certain aspects, the message may be caught immediately after being raised. In this manner, the message may be raised while minimizing adverse impact on service processing, even when multiple messages are triggered. From the consumer's perspective, it may appear as though processing did not pause at all. After being raised, the message may be transferred to the service consumer. In certain aspects, messages triggered during service processing may be appended to a table. This may be implemented through a runtime extension operative to transport raised messages to a table. The service consumer may “listen” for messages appended to the table by the service, allowing the consumer to receive messages raised during processing. In certain aspects consistent with the principles of the present invention, messages may be raised in the following manner:

TRY.
RAISE cm_example_message.
CATCH cm_example message INTO Ir_message.
   APPEND Ir_message TO et_messages.

END TRY.

The RAISE statement may throw the “cm_example_message” message, transferring control to the immediately following CATCH statement. The CATCH statement may restart processing, thus preventing the message from adversely impacting processing. The CATCH statement may also transfer the exception into a local reference variable (i.e. a variable containing a reference to an object), such as “Ir_message” in the above example. The exception may be transferred by the APPEND statement into a table operative to store messages, such as “et_messages” table. The service consumer may retrieve messages from the table. The table may be located in a message buffer. The buffer may comprise a buffer interface. The buffer interface may comprise a signature informing callers, such as the service consumer interested in retrieving messages from the table, how to call the buffer.

As described above, in other aspects, the system may “create” messages modeled as exceptions, such as through the use of a CREATE statement. Created messages may be passed to a table structure, from which they may be retrieved by interested entities, such as the service consumer. In this manner, metadata-containing messages may be passed to the service consumer while minimizing adverse impact on processing. In fact, using a CREATE statement, messages may be triggered without pausing processing at all.

In another aspect, the system may allow messages to be declared in the service signature without modeling them as exceptions. A repository extension may allow messages to be declared in the signature. In this manner, messages may include metadata and may be “raised” without terminating processing, as they do not comprise exceptions.

Referring again to FIG. 2, one or more messages may be triggered during operation of the service provided by service provider 204. Triggered messages may be appended to message table 210 in message handling interface 212. Service consumer 206 may be interested in triggered messages, and may therefore receive messages stored in message table 210, as indicated by arrow 218.

Often, contextual boundaries exist between the service consumer and the service provider, making it difficult or impossible for the service consumer to understand messages generated during processing of the service. For example, a business object node may have two date fields in the elements structure, such as a “begin date” and an “end date.” The service provider may check that both dates are valid by calling a reusable “check date” module. If either the “begin date” or the “end date” is invalid, the “check date” module will generate an error. For example, the module may return an error stating “date invalid.” However, the “date checker” likely has no way to distinguish between the “begin date” and “end date” fields. Consequently, the message returned to the service consumer does not inform the user whether the “begin date” or the “end date” is invalid.

To alleviate this problem, systems and methods consistent with the principles of the present invention may allow contextual mapping between the service provider and the service consumer. For example, in the scenario discussed above, the system may remap the “date” field of the “check date” module to the “begin date” field received by the consumer upon returning information corresponding to the input “begin date,” such that the message passed to the service consumer may include information specific to the field triggering the message. Similarly, when returning information corresponding to the input “end date,” the system may remap the “date” field of the service provider to the “end date” field of the consumer.

In certain aspects, the system may also have to capability to map nodes. For example, the service provider may not require knowledge of the node from which input information arises. However, when a message generated during the service is passed to the consumer, it may be desirable for the consumer to know the node triggering the message. Accordingly, the system may be operative to add the identity of the node generating the message to the message when it is passed from the service provider to the service consumer. Similarly, it may be desirable to replace a message generated by the service provider with another message to be passed to the service consumer. Thus, the system may be operative to remap a message generated by the service provider to a corresponding message for the service consumer.

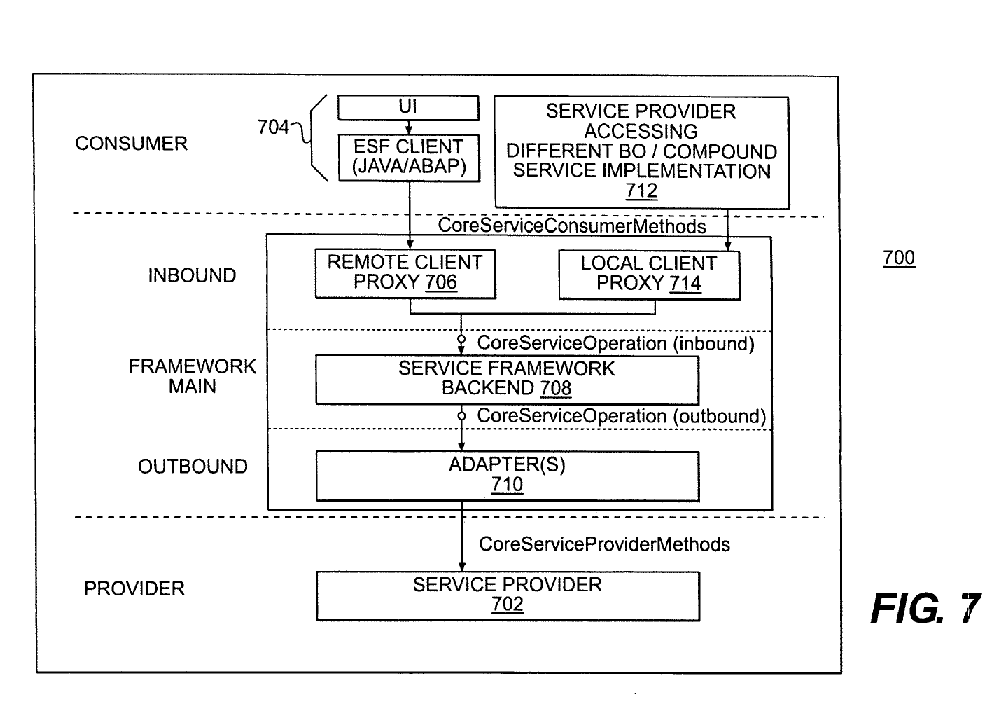

FIG. 7 illustrates dependencies relied upon in passing messages from a service provider to a consumer in a system 700 consistent with the principles of the present invention. As described above, system 700 may comprise a service provider 702 and a remote consumer 704. A framework may exist between remote consumer 704 and service provider 702. The framework may comprise a remote client proxy 206, leading to a service framework backend 708. The framework may also comprise one or more adapters 710 between service framework backend 708 and service provider 702. System 700 may also comprise a local service consumer 712, which may constitute another service provider accessing service provider 702. The framework may comprise a local client proxy 714 interfacing with local service consumer 712. Like remote client proxy 706, local client proxy 714 may interface with service framework backend 708, which interfaces with one or more adapters 708 that interface with service provider 702.

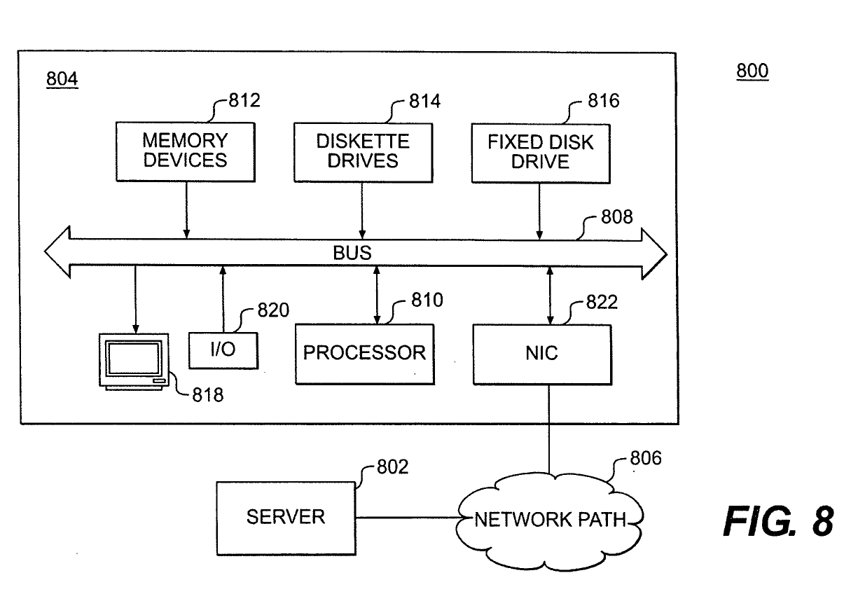

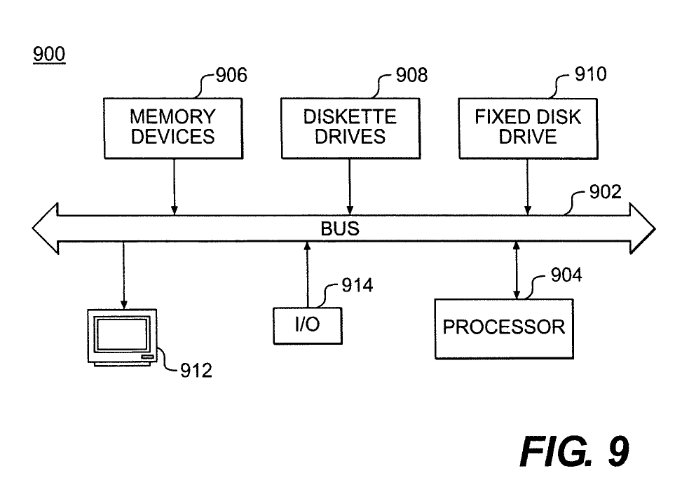

A computer system may be used to install a software application implementing systems and methods providing metadata-containing messages that will minimize any adverse impacts on service processing when raised consistent with the principles of the present invention. The computer system may be a computer network, as shown in FIG. 8, or a stand-alone personal computer (PC), as shown in FIG. 9.

As shown in FIG. 8, a computer network 800 for implementing a system consistent with the principles of the present invention may include a server 802 and a stand-alone PC 804 connected through a network path 806. Computer network 800 may be a local area network (LAN), where server 802 and PC 804 are workstations. Computer network 800 may also be the Internet, with server 802 hosting a web application and PC 804 being any workstation available to a user desiring to interface with the application on server 802. Alternatively, computer network 800 may be a wide area network (WAN), and server 802 and PC 804 may lie in two separate LANs connected through the Internet.

PC 804 may include a bus line 808 connecting a plurality of devices such as a processor 810, memory devices 812 for storage of information, diskette drives 814, a fixed disk drive 816, a monitor 818, other I/O devices 820, and a network interface card (NIC) 822. Processor 810 may be a microprocessor such as an Intel Pentium™ chip for processing applications. Memory devices 812 may include read-only memories (ROM) and/or random access memories (RAM). Diskette drives 814 may include a floppy drive and/or a compact disk (CD) drive. Fixed disk drive 816 may be a hard drive. I/O devices 820 may include a keyboard and/or a mouse for receiving input from a user of PC 804. Monitor 818 may display output from processor 810, and may also echo the input of the user. PC 804 may be connected to network path 806 through NIC 822.

An application may be installed on server 802. An individual desiring to access the application on server 802 may use a web browser loaded on PC 804, and may communicate with server 802 through NIC 822 and network path 806. In certain aspects, a software application implementing a system and/or method consistent with the principles of the present invention may be stored in PC 804 and processor 310 of PC 804 may execute the software application locally within PC 804 and interface with a web application on server 802. Particularly, the software application may be stored on a floppy disk or a CD accessible by diskette drive 814 or on fixed disk drive 816. In another aspect, the software application may be stored in server 802, which may execute the software application, and processor 810 of PC 804 may communicate with server 802 to (i) send information to server 802 and (ii) retrieve the results of the execution of the software application from server 802.

Through the execution of the software application implementing a system and/or method consistent with the principles of the present invention, either locally within PC 804 or remotely within server 802, metadata-containing messages that will minimize any adverse impacts on processing of a service when raised may be provided in accordance with the above description.

Alternatively, as shown in FIG. 9, a stand-alone PC 900 may be used for executing a software application providing metadata-containing messages that will not adversely impact a service when raised during processing consistent with the principles of the present invention. PC 900 may include a bus line 902 connecting a plurality of devices, which may include a processor 904, memory devices 906 for storage of information, diskette drives 908, a fixed disk drive 910, a monitor 912, and other I/O devices 914. Processor 904 may be a microprocessor such as an Intel Pentium™ chip for processing applications. Memory devices 906 may include ROM and/or RAM. Diskette drives 908 may include a floppy drive and/or a compact disk (CD) drive. Fixed disk drive 910 may be a hard drive. Monitor 912 may display the output of processor 904 and may also echo the input of the user. I/O devices 914 may include a keyboard and/or a mouse for receiving input from a user of PC 900.

A software application comprising a system and/or method consistent with the principles of the present invention may be stored on a floppy disk or a CD accessible by diskette drive 908 or on fixed disk drive 910. Processor 904 may execute the software application stored in the floppy disk the CD or the fixed disk drive 910. An individual, through monitor 912 and I/O devices 914, may interact with processor 904, which may execute the software application.

Systems and or methods providing metadata-containing messages that will minimize any adverse impacts on a service when raised during processing may be integrated into a web browser or software application, or may be installed as a plug-in to an existing browser or application. Systems consistent with the principles of the present invention may also be implemented into any transactional application utilizing frames. Systems consistent with the principles of the present invention may be run on either the client side or the server side. However, systems on the client side may reduce impact on the server load, improving system efficiency. A software application implementing a system and/or method consistent with the principles of the present invention may be written in any number of programming languages, including but not limited to JavaScript, Visual Basic, Flash, C, C++, COBOL, and ABAP. Similarly, the present invention is not limited to use with certain applications, Internet browsers or operating systems.

Furthermore, systems and methods consistent with the principles of the present invention may be practiced in an electrical circuit comprising discrete electronic elements, packaged or integrated electronic chips containing logic gates, a circuit utilizing a microprocessor, or on a single chip containing electronic elements or microprocessors. The disclosed systems and methods may also be practiced using other technologies capable of performing logical operations such as, for example, AND, OR, and NOT, including but not limited to mechanical, optical, fluidic, and quantum technologies. In addition, the disclosed systems and methods may be practiced within a general-purpose computer or in any other circuits or systems.

While certain features and embodiments consistent with the principles of the present invention have been described, other embodiments of the invention will be apparent to those skilled in the art from consideration of the specification and practice of the embodiments of the invention disclosed herein. Further, the stages of the disclosed methods may be modified in any manner, including by reordering stages and/or inserting or deleting stages, without departing from the principles of the invention.

It is intended, therefore, that the specification and examples be considered as exemplary only, with a true scope and spirit of the invention being indicated by the following claims and their full scope of equivalents.

What is claimed is:

1. A method, implemented by a computer processor coupled to a memory, for providing metadata-containing messages to interested entities while minimizing adverse impact on service processing comprising:
declaring a metadata-containing message in a signature of a service;
when a condition corresponding to the message occurs, generating the message in a manner minimizing adverse impact on service processing; and
making the message available to an entity interested in the message.

2. The method of claim 1, further comprising raising the message when the condition corresponding to the condition occurs.

3. The method of claim 2, further comprising catching the message.

4. The method of claim 2, further comprising catching the message immediately after it is raised.

5. The method of claim 1, further comprising creating the message when the condition corresponding to the message occurs.

6. The method of claim 1, wherein the message is modeled as an exception.

7. The method of claim 1, wherein the interested entity is a consumer that called the service.

8. The method of claim 7, further comprising remapping a field name upon crossing a contextual boundary between the service and the consumer.

9. The method of claim 7, further comprising remapping a node upon crossing a contextual boundary between the service provider and the service consumer.

10. The method of claim 7, further comprising remapping the message upon crossing a contextual boundary between the service provider and the service consumer.

11. The method of claim 1, wherein the interested entity provides the service.

12. The method of claim 1, wherein the interested entity listens for the message.

13. A computer system comprising:
a memory; and
a processor coupled to the memory, the processor operable to:
declare a metadata-containing message in a signature of a service;
generate the message upon the occurrence of a condition corresponding to the message in a manner minimizing adverse impact on service processing; and
make the message available to an entity interested in the message.

14. The system of claim 13, wherein the processor is operable to raise the message when the condition corresponding to the condition occurs.

15. The system of claim 14, wherein the processor is operable to catch the message.

16. The system of claim 13, wherein the processor is operable to create the message when the condition corresponding to the message occurs.

17. The system of claim 13, wherein the processor is operable to model the message as an exception in the signature.

18. The system of claim 13, wherein the interested entity is a consumer that called the service.

19. The system of claim 13, wherein the interested entity is a provider of the service.

20. A computer-readable medium storing a set of instructions that, when executed, performs a method, the method comprising:
declaring a metadata-containing message in a signature of a service;
when a condition corresponding to the message occurs, generating the message in a manner minimizing adverse impact on service processing; and
making the message available to an entity interested in the message.
